(19) United States
(12) Patent Application Publication
(10) Pub. No.: US 2004/0221830 A1
(43) Pub. Date: Nov. 11, 2004

(54) Cylinder head with machined intake port and process for manufacturing

(75) Inventors: Jessica Kuehner, Nineveh, IN (US); Peter Woon, Columbus, IN (US); David R. Glackin, Columbus, IN (US)

Correspondence Address: GARDNER CARTON & DOUGLAS LLP, ATTN: PATENT DOCKET DEPT., 191 N. WACKER DRIVE, SUITE 3700, CHICAGO, IL, 60606, US

(73) Assignee: Cummins Inc., Columbus, IN

(21) Appl. No.: 10/430,836

(22) Filed: May 6, 2003

(51) Int. Cl. F02F 1/00

(52) U.S. Cl. 123/193.5

(57) ABSTRACT

A cylinder head with improved intake ports and a process for manufacturing such a cylinder head are provided. The process includes providing a cast cylinder head having a cast intake duct with an intake port that opens to a combustion side of the cylinder head and machining a first portion of the intake port so that the first portion has a cylindrical wall that extends generally perpendicular from the opening by a predetermined depth. In an embodiment, the process also includes machining an angled portion of the cast intake port so that the angled portion has a wall that extends adjacently from the first portion at an angle relative thereto. A cylinder head manufactured using the inventive process is also disclosed.

### FIELD OF THE INVENTION

This invention generally relates to internal combustion engines and, more particularly, to an intake port design for a cast cylinder head.

### BACKGROUND OF THE INVENTION

Intake “swirl” is important for efficient and clean combustion in modern diesel engines. Such swirl is generated by the shape and orientation of an intake duct in the cylinder head, creating certain flow characteristics within the combustion chamber or cylinder.

Cylinder heads, and the intake ports therein, are conventionally formed by sand casting. Inherently in the sand casting process, sand can shift and the tooling can degrade after many uses, resulting in variation from part to part. It has been found that changes in the position or shape of the intake ports can cause undesirable variation in the intake swirl behavior, leading to difficulties in meeting emissions criteria.

Accordingly, it is desirable to provide an improved method for making cylinder heads, whereby the resulting cylinder heads are reliably produced from part to part with intake ports that are consistently shaped and positioned.

### SUMMARY OF THE INVENTION

The present invention provides an improved cylinder head as well as a process for manufacturing a cylinder head. In one embodiment, the inventive process includes the steps of: (1) providing a cast cylinder head having a cast intake port with an opening to a combustion side of the cylinder head; and (2) machining a first portion of the intake port, the first portion having a cylindrical wall that extends generally perpendicular from the opening by a predetermined depth. In a specific version of the embodiment, the process also includes the step of machining an angled portion of the cast intake port where the angled portion has a wall that extends adjacently from the cylindrical portion at an angle with respect to the first portion.

In an embodiment, the cylinder head includes a unitarily cast-in swirl-plate projection that extends inwardly toward a center of the intake duct. The swirl-plate projection is positioned and configured to cause intake swirl. Material can be removed from the projection to adjust the flow as desired. For example, material can be removed to form a cylindrical and/or angled sidewall. Such a configuration enables easy adjustment of intake swirl behavior.

The invention also includes a cylinder head that may be manufactured according to the process. For example, the invention includes a cast cylinder head having a cast intake duct with an intake port that opens to a combustion side of the cylinder head. The intake port has a first sidewall portion that is machined so as to extend generally perpendicular to the opening. In an embodiment, the intake port also includes a second sidewall portion that is machined so as to be disposed at an angle with respect to the first portion.

Advantageously, the process can be used to manufacture cylinder heads having intake ports with improved consistency in shape and dimension and which, therefore, exhibit more uniform intake flow behavior. The process enables the intake port design to be easily modified to adjust the resulting intake flow behavior in order to optimize swirl and combustion efficiency.

### BRIEF DESCRIPTION OF THE DRAWINGS

FIG. 1 is a sectional view of a conventional cylinder head having a cast intake port.

FIG. 2 is a sectional view as taken generally along line 11-11 of FIG. 3, the cylinder head having an intake port having features formed in accordance with the present invention.

FIG. 3 is a fragmentary base view of the cylinder head of FIG. 2 as viewed from a combustion side of the cylinder head.

FIG. 4 is a sectional view as taken generally along line IV-IV of FIG. 5, showing a cylinder head having a cast-in swirl plate projection to affect swirl behavior.

FIG. 5 is a base view of a cylinder head of the cylinder head of FIG. 4.

FIG. 6 is a sectional view as taken generally along line VI-VI of FIG. 7, showing the cylinder head of FIGS. 4 and 5 in a condition wherein it has been machined to remove at least a portion of the swirl plate projection.

FIG. 7 is a fragmentary base view of the inventive cylinder head showing the cast-in swirl feature machined away.

### DETAILED DESCRIPTION OF THE INVENTION

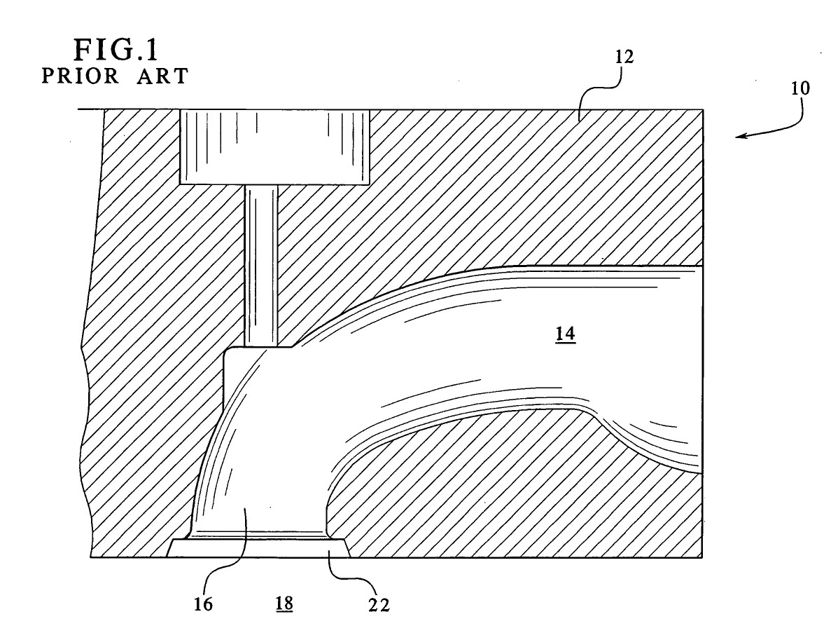

Now referring to the drawings, wherein like numerals designate like components, FIG. 1 illustrates a conventional cylinder head 10. The cylinder head 10 has a metal body 12 formed by casting to include a cast intake duct 14. One end of the intake duct 14 communicates with a combustion chamber and an opposite end communicates with an intake manifold. An intake port 16 is formed at the end of the intake duct 14 that communicates with the combustion chamber. More specifically, the intake port 16 opens to a combustion side 18 of the cylinder head 10 through an opening defined by a valve seat 22. Conventionally, the intake port 16 is defined by walls formed by casting. As discussed above, the nature of casting processes disadvantageously yields surface and dimensional variations among produced components.

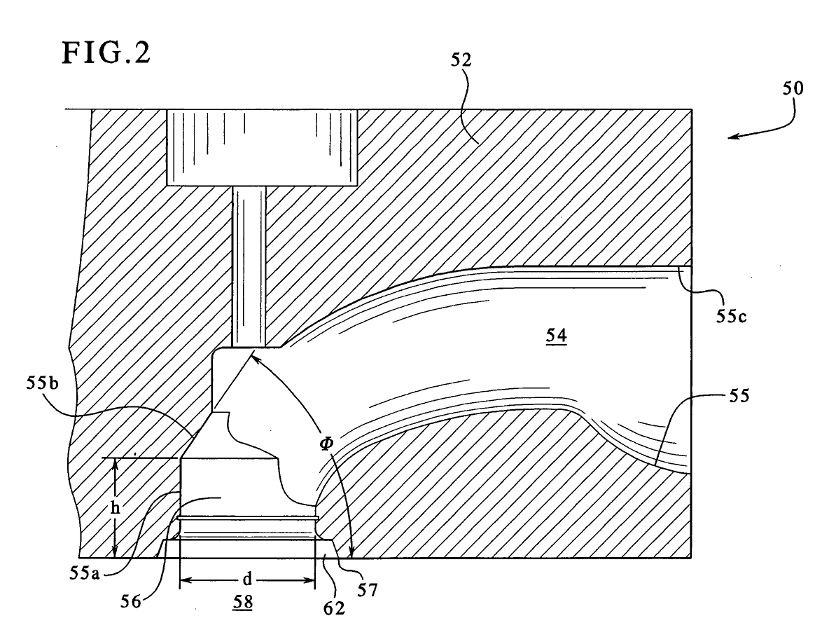

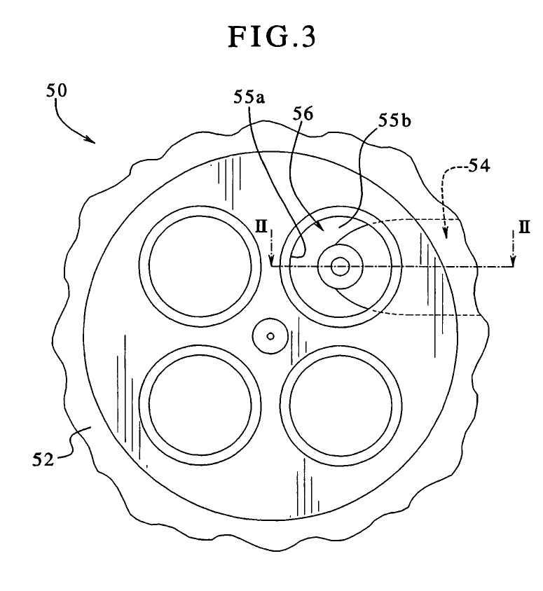

Turning to FIGS. 2 and 3, an exemplary cylinder head 50 is illustrated according to an embodiment of the invention. The cylinder head 50 has a metal body 52 that includes an intake duct 54 defined by a generally tubular wall 55. A distal end 57 of the intake duct 54 includes an air intake port 56 that opens to a combustion side 58 of the cylinder head 50 through an opening defined by a valve seat 62. In an embodiment, the valve seat 62 may be an insert that is mounted in a recess of the metal body 52.

A casting process may be used to initially form the cylinder head 50, including the intake duct 54. According to an aspect of the invention, material is machined away from the cylinder head body 52 to provide one or more smooth, machined-away wall portions, for example first and second sidewall portions 55a, 55b of the intake port 56. Advantageously, the final geometry of the intake port 56 is not ultimately dictated by casting, but rather by the geometry resulting from machining, which can be controlled and repeated with greater precision than casting. The geometry of the sidewall portions 55a, 55b can be selected as desired to provide desired swirl behavior for optimal combustion characteristics. As a result, removing additional material may alter the intake swirl behavior of a particular cylinder. In a manufacturing operation, machining all intake ports to have uniform geometry yields improved uniformity in combustion behavior among multiple cylinders and among multiple engines.

More specifically, referring to FIG. 2, the first sidewall portion 55a extends into the body 52 in the vicinity of the distal end 57 of the duct 54. The first sidewall portion 55a preferably has a smooth cylindrical contour, as illustrated, having a uniform diameter d along a straight axis. In an embodiment, the first sidewall portion 55a is at a generally perpendicular orientation relative to the combustion side 58 of the cylinder head 50. The first sidewall portion 55a has a dimension h, which represents a predetermined maximum depth reached by a point of the sidewall portion 55a.

In an embodiment, the second sidewall portion 55b may be formed by machining. As shown in FIGS. 2 and 3, the second sidewall portion 55b has a smooth, generally cylindrical contour and is disposed at an angle Φ with respect to the first portion. The duct 54 includes a cast portion 55c that is not machined, but which instead has a surface formed by the casting process.

As used herein, “machining” refers to any operation for removing material from a metal object. For example, machining can include the use of a rotary power tool that affects a cutting or abrasive action, such as by grinding, boring, milling, drilling, etc.

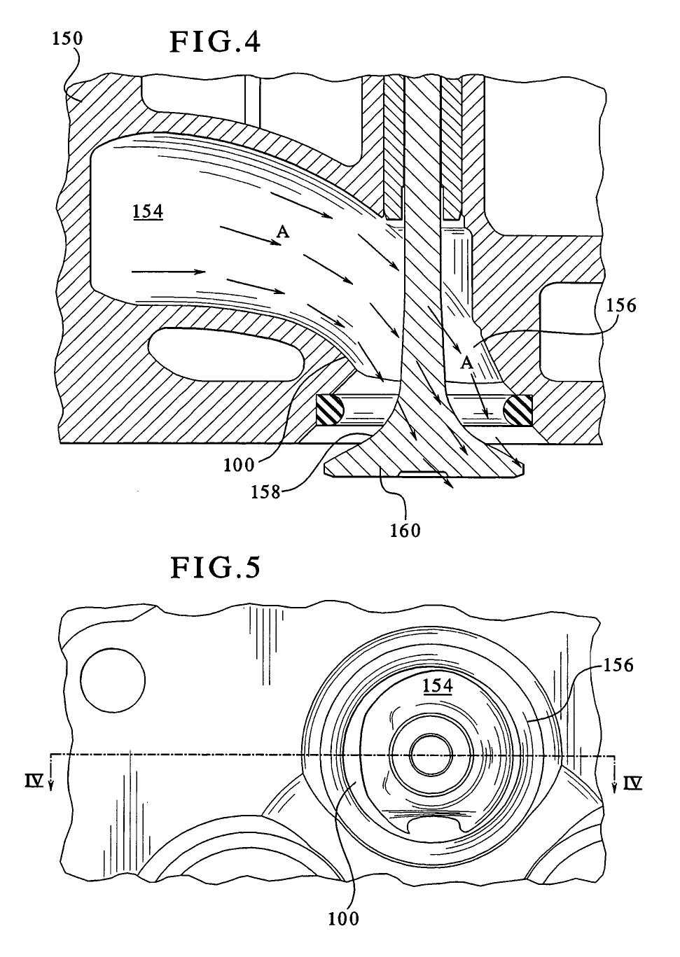

Now turning to FIGS. 4 and 5, a cast cylinder head 150 includes an intake duct 154 having a cast-in swirl-plate projection 100 that is provided for affecting swirl behavior. The projection 100 extends inwardly toward a center of the duct 154. Generally, the amount of swirl can be increased by directing the flow A of intake air from the intake port 156 into the cylinder in a more lateral direction (more horizontally with respect to the orientation of FIG. 4). The cast-in projection 100 shrouds a portion of an upstream side 158 of the intake valve 160, forcing air flow A to exit from the intake port 156 in a direction having a horizontal component, causing a swirl effect in the cylinder.

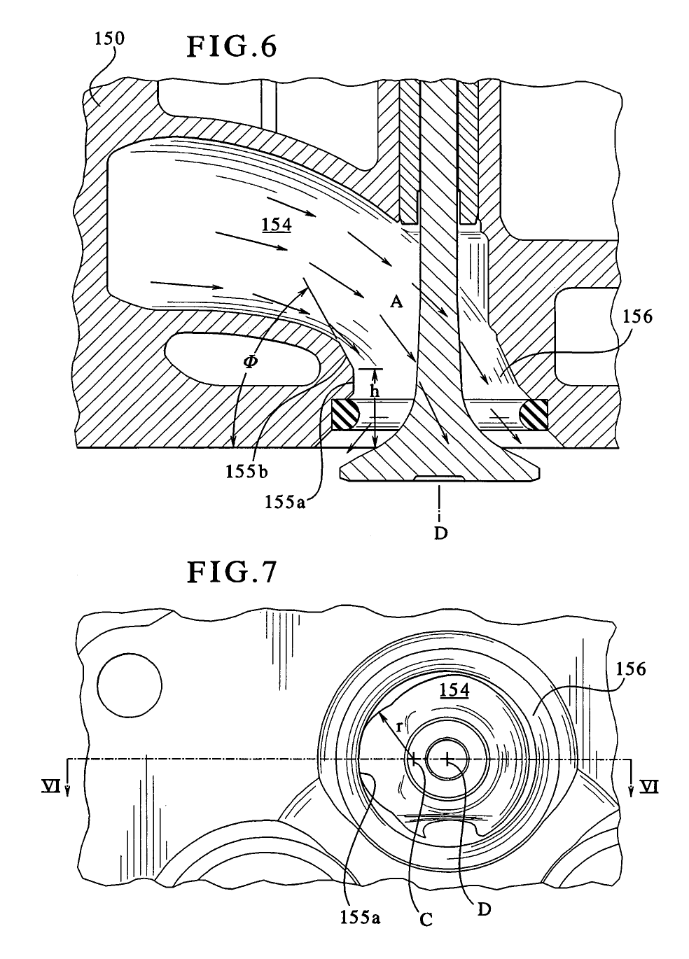

According to an embodiment of the invention, referring to FIGS. 6 and 7, first and second sidewall portions, 155a and 155b respectively, are provided in the duct 154 to define an intake port 156. The first and second sidewall portions 155a and 155b may be formed by machining away material from the swirl-plate projection 100. In the illustrated example, the first sidewall portion 155a has a cylindrical contour and is oriented generally perpendicular to the combustion side of the cylinder head 150. An amount of swirl is decreased by directing the intake flow A in a direction that is more vertical downward in to the cylinder. By providing the first and second sidewall portions 155a, 155b with a precise removal of material from the projection 100, the amount of swirl may be controlled to a target value. Additionally, precisely machining the first and second sidewall portions 155a and 155b to provide a generally uniform desired geometry at each intake port 156 yields improved uniformity in combustion characteristics among multiple cylinders and engines.

As shown in FIG. 6, the first sidewall portion 155a has, at a point, a depth h. The second sidewall portion 155b has a smooth, generally cylindrical contour and is disposed at an angle Φ with respect to the first portion 155a. Also, referring to FIG. 7, the first sidewall portion 155a preferably has a cylindrical contour with a radius r around a central axis C. The central axis C of the first sidewall portion 155a may be offset from a central axis D of the valve 160. Any of these dimensions may be varied to change swirl behavior as desired.

As the term is used herein, the “cylindrical” is used to describe a surface curvature or contour as defined by at least a part of a cylinder, which has a constant radius along a central axis. The surfaces of the first and second wall portions, e.g. 55a and 55b (FIGS. 2 and 3), 155a, 155b (FIGS. 6 and 7) are illustrated as “cylindrical.” Notably, the surfaces of the first and/or second wall portions may or may not be annular.

The amount of swirl in the cylinder 150 can be altered depending on how much material 100 is machined away from the intake port 156 and the resulting geometry. The machined sidewall portions 155a, 155b can be formed in progressive steps in order to reduce the swirl level to a target value. This ability to effect the swirl level is important because the requirements for the level of swirl in a cylinder head typically change in order to satisfy increased emission standards. In the past, extensive flow testing and costly casting modifications have been required in order to determine an intake port geometry that exhibits suitable flow characteristics. The structure and process of the present invention will ease the testing process and reduce costs. For example, in order to allow for the modifications necessary to reduce the swirl level, an intake duct can have an intake port with a cast-in swirl plate designed to yield a high level of swirl. This swirl plate can be machined away in progressive steps, thereby reducing the swirl to the target value. Should the target value change, the machining cut can be adjusted to remove more or less material and, as a result, adjust the swirl level. This allows for a quick, low cost, response to meet changing emission requirements of certain engines.

The use of the terms “a” and “an” and “the” and similar referents in the context of describing the invention (especially in the context of the following claims) are to be construed to cover both the singular and the plural, unless otherwise indicated herein or clearly contradicted by context. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. It should be understood that the illustrated embodiments are exemplary only, and should not be taken as limiting the scope of the invention.

1. A process for manufacturing a cylinder head, the process comprising:
providing a cast cylinder head including an cast intake duct having a cast intake port with an opening to a combustion side of the cylinder head; and
machining a first portion of the intake port, the first portion having a cylindrical wall that extends generally perpendicular from the opening by a predetermined depth, whereby the duct has a non-helical shape adjacently upstream of the first portion.

2. (Canceled)

3. The process of claim 1, further comprising:
machining a second portion of the cast intake port, the second portion having a wall that extends adjacently from the first portion at an angle with respect to the first portion.

4. The process of claim 3, wherein the wall of the second portion has a generally cylindrical curvature.

5. The process of claim 3, further comprising a step of subsequently machining the second portion to vary the angle.

6. The process of claim 3, wherein the cylinder head includes a cast swirl-plate projection that projects inwardly toward a center of the intake duct, and wherein the step of machining the second portion includes removing material from the swirl-plate projection to form the angled portion.

7. The process of claim 1, wherein the first portion has a diameter, the process further comprising subsequently machining the first portion to enlarge the diameter.

8. The process of claim 1, further comprising subsequently machining the first portion to increase the predetermined depth.

9. A cylinder head comprising a cast cylinder head body including a cast intake duct having an intake port in communication with combustion side of the cylinder head, wherein the intake port includes a first wall portion that is formed by machining material away from the cast intake duct, wherein the first wall portion has a cylindrical shape, the first wall portion extending generally perpendicularly from the opening by a predetermined depth, wherein the duct has a non-helical shape adjacently upstream of the first wall portion.

10. The cylinder head of claim 9, wherein the cylinder head further comprises a unitarily cast swirl-plate projection that extends toward a center of the intake duct, and wherein the first wall portion is formed by machining away material from the projection.

11. The cylinder head of claim 9, wherein the intake port further includes a second wall portion formed by machining away material from the cast intake duct, the second wall portion being disposed at an angle relative to the cast intake port, the second wall portion extends adjacently from the first portion at an angle with respect to the first portion.

12. The cylinder head of claim 11, wherein the second wall portion has a generally cylindrical curvature.

13. The cylinder head of claim 11, wherein the cylinder head further comprises a unitarily cast swirl-plate projection that extends toward a center of the intake duct, and wherein the second wall portion is formed by machining away material from the projection.

14. A cylinder head for an internal combustion engine, the cylinder head comprised of:
a cylinder head having an intake port with an opening to a combustion side of the cylinder head;
a first sidewall portion of the intake port extending generally perpendicularly to the opening; and
a second sidewall portion of the intake port that extends adjacently from the first sidewall portion and which is angled with respect to the first portion.

15. The cylinder head of claim 14, wherein the first sidewall portion is cylindrical.

16. The cylinder head of claim 14, wherein the second sidewall portion is cylindrical.

17. The cylinder head of claim 14, wherein the first sidewall portion is smooth.

18. The cylinder head of claim 14, wherein the second sidewall portion is smooth.

19. A process for manufacturing a cylinder head, the process comprising:
providing a cast cylinder head including an cast intake duct having a cast intake port with an opening to a combustion side of the cylinder head; and machining a first portion of the intake port, the first portion having a cylindrical wall that extends generally perpendicular from the opening by a predetermined depth, wherein the cylinder head includes a cast swirl-plate projection that projects inwardly toward a center of the intake duct, and wherein the step of machining the first portion includes machining material from the swirl-plate projection to form the cylindrical wall.

20. A process for manufacturing a cylinder head, the process comprising:
providing a cast cylinder head including an cast intake duct having a cast intake port with an opening to a combustion side of the cylinder head;
machining a first portion of the intake port, the first portion having a cylindrical wall that extends generally perpendicular from the opening by a predetermined depth; and
machining a second portion of the cast intake port, the second portion having a wall that extends adjacently from the first portion at an angle with respect to the first portion, whereby the wall of the second portion has a generally cylindrical curvature.

21. A process for manufacturing a cylinder head, the process comprising:
providing a cast cylinder head including an cast intake duct having a cast intake port with an opening to a combustion side of the cylinder head; and
machining a first portion of the intake port, the first portion having a cylindrical wall that extends generally perpendicular from the opening by a predetermined depth;
machining a second portion of the cast intake port, the second portion having a wall that extends adjacently from the first portion at an angle with respect to the first portion; and
subsequently machining the second portion to vary the angle.

22. A process for manufacturing a cylinder head, the process comprising:
providing a cast cylinder head including an cast intake duct having a cast intake port with an opening to a combustion side of the cylinder head;
machining a first portion of the intake port, the first portion having a cylindrical wall that extends generally perpendicular from the opening by a predetermined depth; and
machining a second portion of the cast intake port, the second portion having a wall that extends adjacently from the first portion at an angle with respect to the first portion;
wherein the cylinder head includes a cast swirl-plate projection that projects inwardly toward a center of the intake duct, and wherein the step of machining the second portion includes removing material from the swirl-plate projection to form the angled portion.

23. A process for manufacturing a cylinder head, the process comprising: providing a cast cylinder head including an cast intake duct having a cast intake port with an opening to a combustion side of the cylinder head; and machining a first portion of the intake port, the first portion having a cylindrical wall that extends generally perpendicular from the opening by a predetermined depth wherein the first portion has a diameter, the process further comprising subsequently machining the first portion to enlarge the diameter, wherein the first portion has a diameter, the process further comprising subsequently machining the first portion to enlarge the diameter.

24. A process for manufacturing a cylinder head, the process comprising:
providing a cast cylinder head including an cast intake duct having a cast intake port with an opening to a combustion side of the cylinder head; and machining a first portion of the intake port, the first portion having a cylindrical wall that extends generally perpendicular from the opening by a predetermined depth; and subsequently machining the first portion to increase the predetermined depth.

25. A cylinder head comprising:
a cast cylinder head body including a cast intake duct having an intake port in communication with combustion side of the cylinder head, wherein the intake port includes a first wall portion that is formed by machining material away from the cast intake duct, wherein the first wall portion has a cylindrical shape, the first wall portion extending generally perpendicularly from the opening by a predetermined depth; and
a unitarily cast swirl-plate projection that extends toward a center of the intake duct, and wherein the first wall portion is formed by machining away material from the projection.

26. A cylinder head comprising a cast cylinder head body including a cast intake duct having an intake port in communication with combustion side of the cylinder head, wherein the intake port includes a first wall portion that is formed by machining material away from the cast intake duct, wherein the first wall portion has a cylindrical shape, the first wall portion extending generally perpendicularly from the opening by a predetermined depth, wherein the intake port further includes a second wall portion formed by machining away material from the cast intake duct, the second wall portion being disposed at an angle relative to the cast intake port, the second wall portion extends adjacently from the first portion at an angle with respect to the first portion, wherein the second wall portion has a generally cylindrical curvature.

27. A cylinder head comprising a cast cylinder head body including a cast intake duct having an intake port in communication with combustion side of the cylinder head, wherein the intake port includes a first wall portion that is formed by machining material away from the cast intake duct, wherein the first wall portion has a cylindrical shape, the first wall portion extending generally perpendicularly from the opening by a predetermined depth, wherein the intake port further includes a second wall portion formed by machining away material from the cast intake duct, the second wall portion being disposed at an angle relative to the cast intake port, the second wall portion extends adjacently from the first portion at an angle with respect to the first portion, wherein the cylinder head further comprises a unitarily cast swirl-plate projection that extends toward a center of the intake duct, and wherein the second wall portion is formed by machining away material from the projection.
